(19) United States
(12) Patent Application Publication
(10) Pub. No.: US 2010/0185735 A1
(43) Pub. Date: Jul. 22, 2010

(54) EXTENSIBILITY FOR HOSTED MESSAGING SERVERS

(75) Inventors: Wilbert De Graaf, Bellevue, WA (US); Jeffrey B. Kay, Bellevue, WA (US); Khalid Razzag, Redmond, WA (US); Saeed Noursalehi, Redmond, WA (US); Victor Boctor, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/356,552

(22) Filed: Jan. 21, 2009

(51) Int. Cl. G06F 15/16

(52) U.S. Cl. 709/206

(57) ABSTRACT

Architecture for messaging server extensibility without the need to update or make changes to the messaging server by routing selected messages to a remote location for processing by custom code or third-party code. The messaging server routes the selected messages based server analysis of the messages and in view of configuration data (or conditions) for routing messages. The remote location processes the message and can instruct the messaging server to accept, reject, or redirect the message. Additionally, the remote location can modify the message and instruct the messaging server to process the modified message. The hosted organization can configure triggers to have the messaging server call to a web service with the messages, which extends the functionality of the messaging server.

### BACKGROUND

Messaging servers that process messages, typically provide a mechanism for others to extend the functionality. Examples are spam and virus scanners that inspect messages as the messages pass through the system. As long as these messaging servers are only running a manageable number of such extensions, it is doable to run the executables within the same server, or even the process. However, if the messaging servers are processing messages from many different organizations, and several of those organizations have a need for different extensions, this quickly becomes unmanageable.

Problems related to unmanageability include upgrade and compatibility issues, robustness, and deployment. With respect to upgrade and compatibility issues, a new version of the server software can require all other software to be compatible. Moreover, any additional software product can cause trouble, and requires immediate support from the other vendors. Such problems oftentimes impact mail flow of other organizations as well. The deployment and configuration of software from different vendors requires additional deployment steps for each additional extension and with that, most likely coordination such as potential licensing.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides messaging server extensibility without the need to update or make changes to the messaging server by routing selected messages to a remote location for processing by custom code or third-party code. The messaging server routes the selected messages based on server analysis of the messages based on configuration data (or conditions) for routing messages.

In one implementation, based on the message (e.g., from a different organization) and analysis thereof using the configuration data, the messaging server is triggered to call the remote location (which can be a web service). The remote location acts on the message and reports back to the messaging server as to handling of the message. There can be a different set of configuration data for each hosted organization so that only messages that belong to that organization are affected. In other words, the same message sent to two different organizations can be handled differently based on the corresponding configuration data.

An example is that an organization can specify that if a message arrives from another domain, then call a web service at a specified address and send the organization the whole message. In response, the web service can instruct the messaging server to accept, reject, or redirect the message. The organization can also modify the message and instruct the messaging server to continue to process the now modified message. The web service can also modify the message and instruct the messaging server to continue to process the now modified message.

With this capability, hosted organizations can configure such triggers to have the messaging server call to a web service with the messages and rely on that to extend the functionality of the messaging server. The hosted organization can handle specifics such as licensing, configurations and service level agreements with the entity that owns the web server that runs the web service configured.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented message communications system in accordance with the disclosed architecture.

FIG. 2 illustrates an extensible messaging server system that employs a configuration component.

FIG. 3 illustrates a system where the messaging server can interact with multiple web services based on corresponding sets of configuration data.

FIG. 4 illustrates examples of the configuration data (conditions) that can be created and employed for message processing and routing.

FIG. 5 illustrates examples of the message information that can be sent to the remote location for custom code processing.

FIG. 6 illustrates examples of the instruction(s) that can be passed from the remote location to the messaging server and/or routing component.

FIG. 7 illustrates a method of processing messages.

FIG. 8 illustrates a method of composing message information for sending to the remote location.

FIG. 9 illustrates a method of responding with instruction(s) for processing at the messaging server.

FIG. 10 illustrates a block diagram of a computing system operable to function as a server for facilitating extensibility for hosted messaging servers in accordance with the disclosed architecture.

FIG. 11 illustrates a schematic block diagram of a computing environment that facilitates messaging server extensibility in accordance with the disclosed architecture.

### DETAILED DESCRIPTION

The disclosed architecture includes a feature for a messaging server (e.g., email server) to call out to a web service to extend the functionality of the messaging server. Additionally, conditions (rules) can be configured under which the messaging server calls the web service, which web service, and the information the messaging server sends to the web service. The architecture also provides ability of the protocol to negotiate what information to send to the web service.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

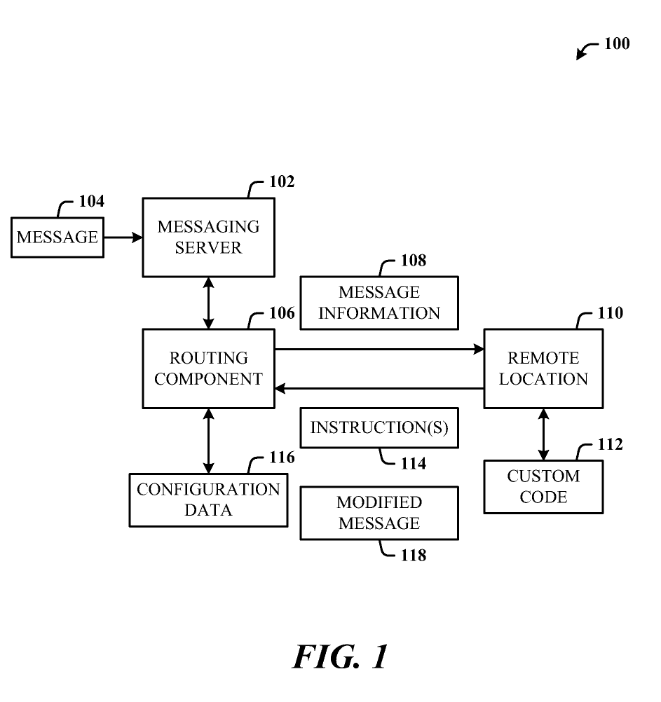

FIG. 1 illustrates a computer-implemented message communications system 100 in accordance with the disclosed architecture. The system 100 includes a messaging server 102 for receiving a message 104, and a routing component 106 for routing message information 108 of the message 104 to a remote location 110 for processing using custom code 112 and returning instruction(s) 114 to the message server 102 as to handling of the message 104. The routing component 106 processes configuration data 116 that describes conditions for routing the message 104, to which remote location of a plurality of remote locations the message 104 is to be routed, and message information to be sent from the messaging server 102 to the remote location 110. The message information 108 indicates the message 104 is from a source outside of a domain of the messaging server 102. Note, however, that the message does not have to be from a source outside the domain of the messaging server 102, but can be a message from within the organization to an entity within the organization, and/or a message from within the organization directed to outside the organization.

The instructions 114 received from the remote location 110 indicate to the messaging server 102 to accept or reject the message 104. The remote location 110 can also apply message moderation where the remote location 110 can indicate to the messaging server 102 to defer delivery of the message 104 until further notice. The defer action can include rejecting or passing the message 104 once the remote location 110 has decided what to do. The instructions 114 received from the remote location 110 can also indicate to the messaging server 102 to redirect the message 104. The routing component 106 can send the message 104 to the remote location 110; the remote location 110 modifies the message 104, returns a modified message 118 to the messaging server 102, and returns instructions 114 to the messaging server 102 as to processing of the modified message 118. Still further, note that the remote location 110 can change the sender and/or recipient(s) under the general ability to modify the message 104.

The routing component 106 can send the message 104 to the remote location 110; the remote location 110 processes the message information 108, and sends the message 104 directly to a recipient based on the message information 108. The routing component 106 can send additional information to the remote location 110 in response to a request from the remote location 110. Where the remote location is a web service, the routing component 106 can issue a web service call to the web service.

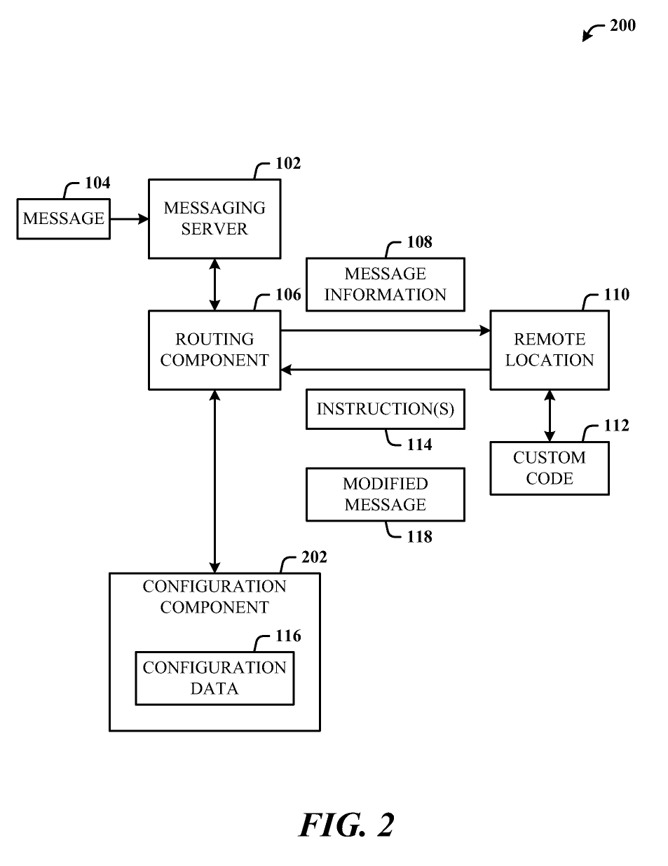

FIG. 2 illustrates an extensible messaging server system 200 that employs a configuration component 202. The system 200 includes the messaging server 102 for receiving the message 104, and the routing component 106 for routing message information 108 of the message 104 to the remote location 110 for processing using custom code 112 and returning instruction(s) 114 to the message server 102 as to handling of the message 104, as described in system 100 of FIG. 1.

The system 200 includes the configuration component 202 for creating the configuration data 116 that describes conditions for dealing with the message 104. For example, the type of message information 108 passed to the remote location 110 can be set as conditions in the configuration data 116. Moreover, whether to pass both the message information 108 and the message 104 to the remote location 110 can be provided in the configuration data 116. Additionally, whether the message 104 sent to the remote location 110 is modifiable (and returned as the modified message 118) can be stipulated in the configuration data 116. Other conditions can also derived and set in the configuration, as desired. Moreover, the modified message can be transmitted directly from the remote location to the intended recipient(s).

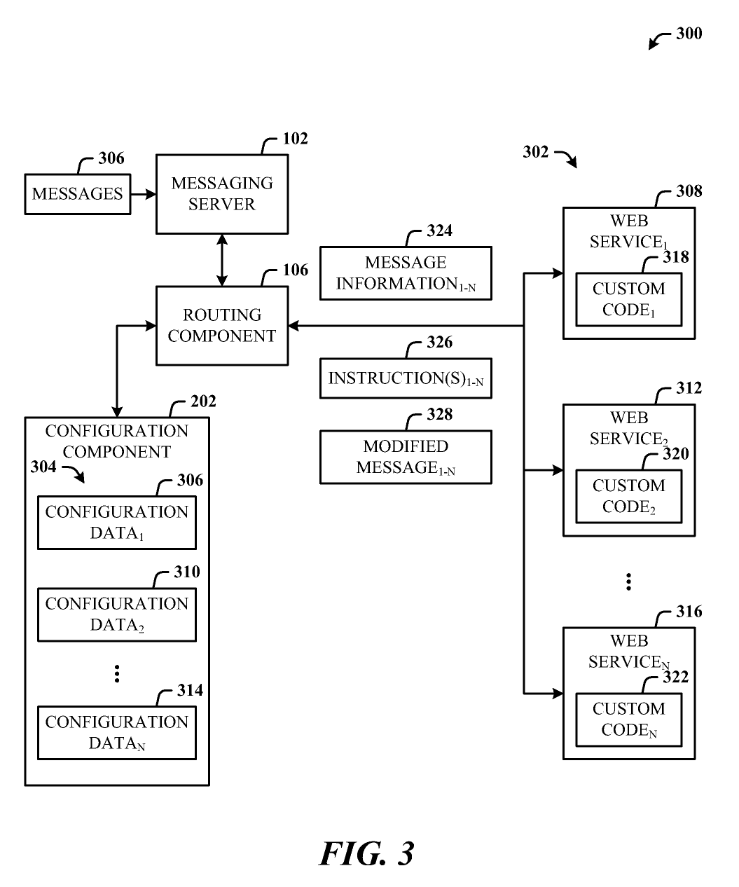

FIG. 3 illustrates a system 300 where the messaging server 102 can interact with multiple web services 302 based on corresponding sets of configuration data 304. Here, the messaging server 102 can receive and process messages 306, any one or more of which can be rerouted to web services 302 (denoted Web Service₁, Web Service₂, . . . , Web Service_{N}) for processing by associated custom code (denoted Custom Code₁, Custom Code₂, . . . , Custom Code_{N}), and according to the corresponding configuration data 304 (denoted Configuration Data₁, Configuration Data₂, . . . , Configuration Data_{N}). For example, the user (e.g., administrator) can create first configuration data 306 for a first web service 308, second configuration data 310 for a second web service 312, and an Nth configuration data 314 for an Nth web service 316. The web services 302 can each run different custom code: the first web service 308 running a first custom code 318, the second web service 312 running a second custom code 320, and the Nth web service 316 running an Nth custom code 322.

Depending on the configuration data 304, the web services 302 can receive message information 324 (denoted Message Information_{1-N}); and, optionally, the web services can also send the associated message (of the messages 306) for each of the web services 302. In response, the web services 302 can return one or more instruction(s) 326 (denoted Instruction(s)_{1-N}) to the messaging server 102 and/or routing component 106, as well as, or not at all, an associated modified message 328 (denoted Modified Message_{1-N}).

As will be described hereinafter, conditions in the configuration data 304 can also include routing a message to multiple different web services 302, rather than to a single web service.

As illustrated, different web services can be called by allowing the organization administrator to supply the address of the web service by supplying the URL, for example. A call to a remote web service can be at any stage of message processing; for instance, before the message gets accepted from another system or when the message is ready to leave the system. In the latter case, the web service can take care of the message delivery instead of the messaging server 102.

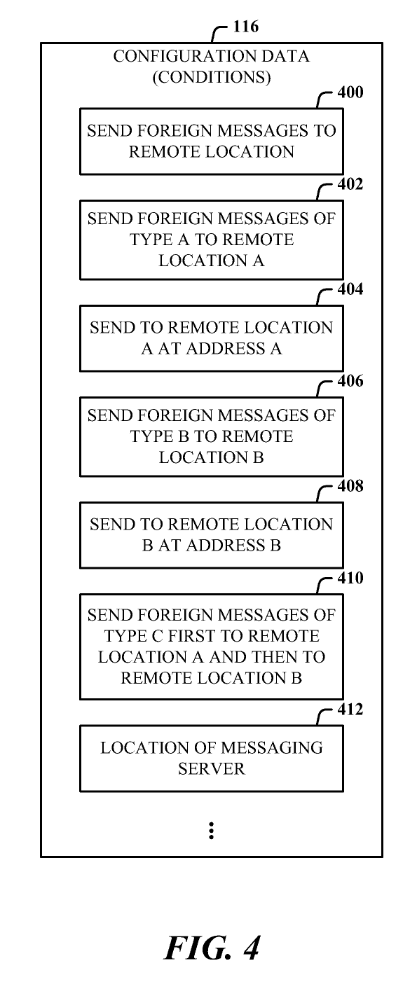

FIG. 4 illustrates examples of the configuration data (conditions) 116 that can be created and employed for message processing and routing. The data 116 can include a first condition (or rule) 400 for directing all foreign messages to a remote location. Here, foreign means a message originating from outside the network boundaries, organization, domain, department, etc., than the location of the messaging server. For example, if the message originates from a different company, the message can be routed for custom code processing at the designated remote location (e.g., web service). If the message originates from a different corporate department network, the message can be routed for custom code processing at the designated remote location. If the message originates from a different corporate sub-network of the same department, the message can be routed for custom code processing at the designated remote location. As can be seen, the flexibility for handling the desired messages are limited only by the conditions employed in the configuration data.

A second condition 402 sends the foreign message of a specific type (Type A) to a corresponding remote location (Location A). A third condition 404 sends to Remote Location A at an address A (e.g., URL—uniform resource locator for the Remote Location A). A fourth condition 406 sends the foreign message of a specific type (Type B) to a corresponding remote location (Location B). A fifth condition 408 sends to Remote Location B at an address B provides the address for the location B. A sixth condition 410 stipulates to send foreign messages of a Type C first to the Remote location A and then to the Remote Location B. An additional condition of the configuration data 116 can include the location (e.g., address) of the messaging server. As indicated, other conditions can be created and imposed as desired.

The messaging server can include the capability of defining conditions, the corresponding feature also referred to as transport rules. Examples of conditions include, if the message has a header name ‘X’ with a value of ‘Y’, or if the message comes in from another domain.

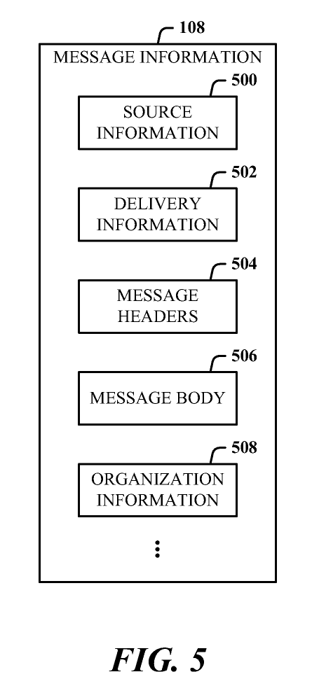

FIG. 5 illustrates examples of the message information 108 that can be sent to the remote location for custom code processing. Here, the message information 108 is depicted as including source information 500 (e.g., client IP address, authenticated user, time, and submission protocol, etc.) for the source of the message, delivery information 502 (e.g., arrival time, delivery status, etc.), message headers 504 (e.g., MIME-multipurpose mail Internet extensions), the message body 506 (e.g., textual content, links, etc.), and a set or subset of the organization's configuration 508. Other message information can be sent, as desired.

As described, the remote location can optionally, request more information. For instance, initially the messaging server can send all message information except the message body. On further inspection, the remote location may decide to also analyze the message (the body) and request to also receive the body of the message.

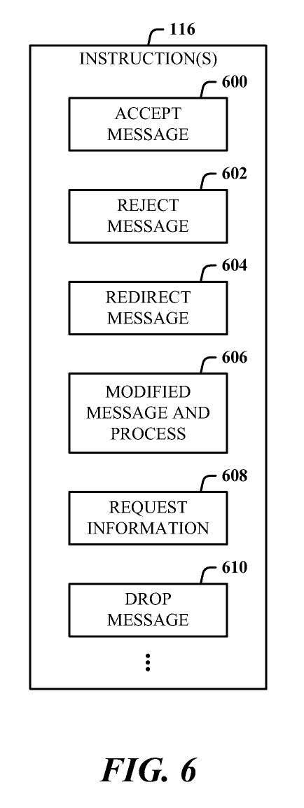

FIG. 6 illustrates examples of the instruction(s) 116 that can be passed from the remote location to the messaging server and/or routing component. The web service instruction(s) 116 (response) can include the following: an accept response 600 to instruct the messaging server to accept the message (continue processing), a reject response 602 to instruct the messaging server to reject the message (and optionally, with a reason as to why the message was rejected), a redirect response 604 to instruct the messaging server to redirect the message based on modified set of recipients, a modified message and process response 606 to instruct the messaging server to continue processing the modified version, a request response 606 to instruct the messaging server to send more information, and a drop response 608 to drop the message (e.g., the web service further processes the message). Other instructions(s) 116 can be coded for use, as well.

A messaging server typically has service level agreements associated with message latencies. Since the remote locations (e.g., web services) can be outside of the control of the organization that is hosting the messaging server, the impact of the latency caused by the web services can be reported separately, and optionally, not count negatively toward the latency results for the messaging server.

Put another way, a computer-implemented message communications system is provided that includes a messaging server for sending and receiving messages, a configuration component for defining conditions under which the messaging server calls a web service, and a routing component for routing the message to the web service according to one or more of the conditions, the web service processing the message using custom code and returning instructions to the messaging server as to handling of the message.

The conditions can describe criteria for initiating routing of the message, a web service of a plurality of web services that the message is to be routed, and the message information to be sent from the messaging server to the selected web service. The web service returns instructions to the messaging server to accept the message, reject the message, or to redirect the message. The web service can modify the message, returns the modified message to the messaging server, and/or returns instructions to the messaging server to continue processing the modified message. The web service can also request additional information from the messaging server as part of processing the message.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

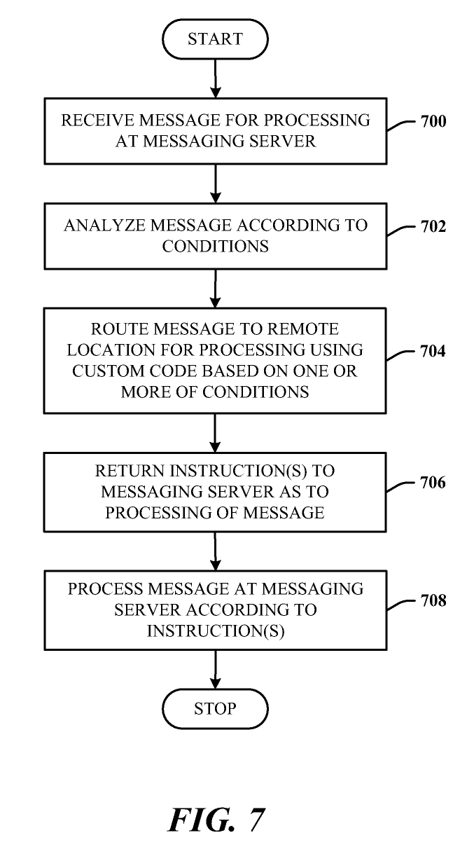

FIG. 7 illustrates a method of processing messages. At 700, a message is received for processing at a messaging server. At 702, the message is analyzed according to conditions. At 704, the message is routed to a remote location for processing using custom code based on one or more of the conditions. At 706, instructions are returned to the messaging server as to processing of the message. At 708, the message is processed at the messaging server according to the instructions.

The method can further comprise accepting or rejecting the message at the messaging server based on the instructions, and routing the message to the remote location, which is a web service, based on the message being received from a network external to a domain of the messaging server.

The method can further comprise sending additional message information to the remote location in response to a request for the additional message information by the remote location. The method can further comprise receiving a modified message from the remote location, the remote location modifying the message, and processing the modified message according to the instructions. The method of claim 15, further comprising reporting latency parameters of the messaging service independent of latency data of the remote location.

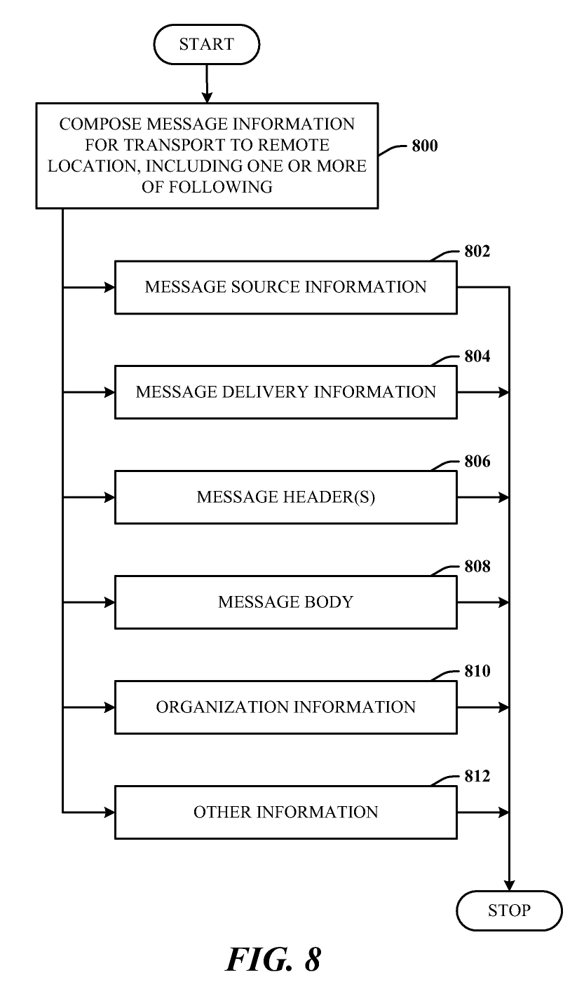

FIG. 8 illustrates a method of composing message information for sending to the remote location. At 800, message information is composed for transport to a remote location. The message information can include one or more of the following. At 802, message source information can be added. At 804, message delivery information can be added. At 806, message header(s) can be included. At 808, the message body can be added. At 810, organization information can be included. At 812, other information can be included.

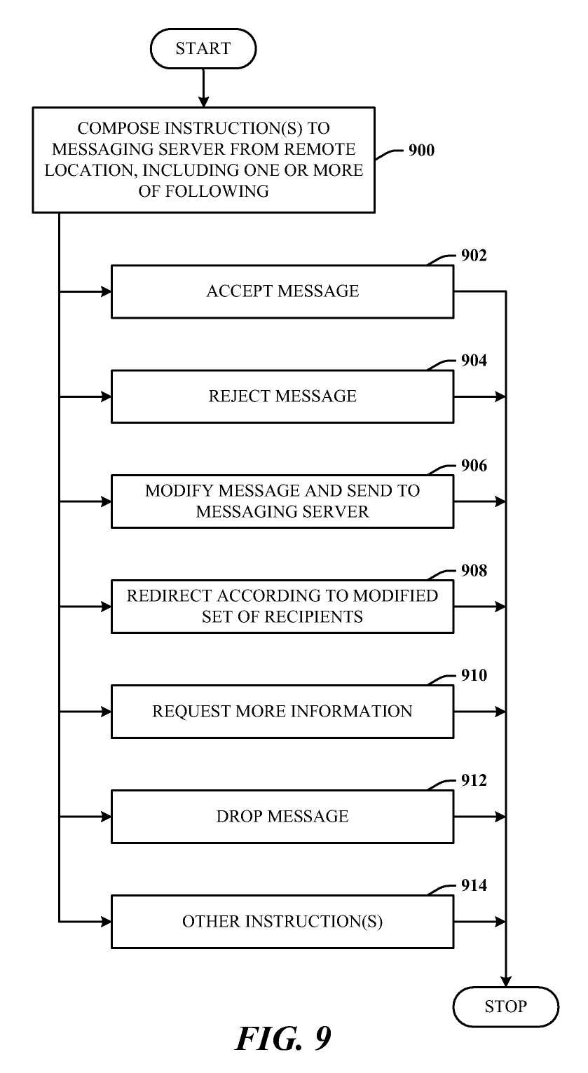

FIG. 9 illustrates a method of responding with instruction(s) for processing at the messaging server. At 900, instruction(s) are composed for transmission to the messaging server from the remote location. At 902, the messaging server is instructed to accept the message. At 904, the messaging server is instructed to reject the message. At 906, the messaging server is instructed to process a modified message received from the remote location. At 908, the messaging server is instructed to redirect the message to a modified set of recipients. At 910, the messaging server is instructed to provide more information. At 912, the messaging server is instructed to drop the message. At 914, the messaging server is instructed according to other instruction(s).

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

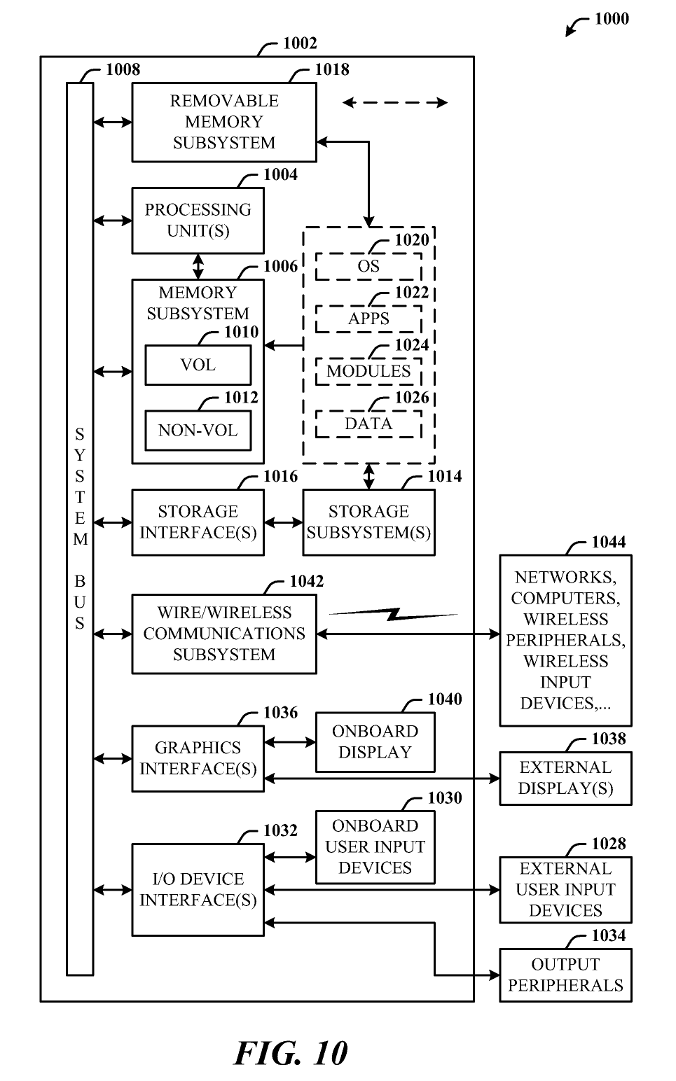

Referring now to FIG. 10, there is illustrated a block diagram of a computing system 1000 operable to function as a server for facilitating extensibility for hosted messaging servers in accordance with the disclosed architecture. In order to provide additional context for various aspects thereof, FIG. 10 and the following discussion are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the memory subsystem 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes storage subsystem(s) 1014 and storage interface(s) 1016 for interfacing the storage subsystem(s) 1014 to the system bus 1008 and other desired computer components. The storage subsystem(s) 1014 can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a removable memory subsystem 1018 (e.g., flash drive form factor technology), and/or the storage subsystem(s) 1014, including an operating system 1020, one or more application programs 1022, other program modules 1024, and program data 1026. Where the computer 1002 is a server machines, the one or more application programs 1022, other program modules 1024, and program data 1026 can include the messaging server 102, routing component 106, configuration data 116, message 104, message information 108, instruction(s) 114, modified message 118, of FIG. 1, the additional component 202 of FIG. 2, the messages_{1-N} 306, configuration data_{1-N} 304, message information_{1-N} 322, instruction(s)_{1-N} 326, modified message_{1-N} 328 of FIG. 3, configuration data 116 and conditions of FIG. 4, message information 108 and information of FIG. 5, instruction(s) 116 of FIG. 6, and some or all of the methods of FIGS. 7-9, for example.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Computer readable media can be any available media that can be accessed by the computer 1002 and includes volatile and non-volatile media, removable and non-removable media. For the computer 1002, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP) using logical connections via a wired/wireless communications subsystem 1042 to one or more networks and/or other computers. The other computers can include workstations, servers, routers, personal computers, microprocessor-based entertainment appliance, a peer device or other common network node, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or has other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

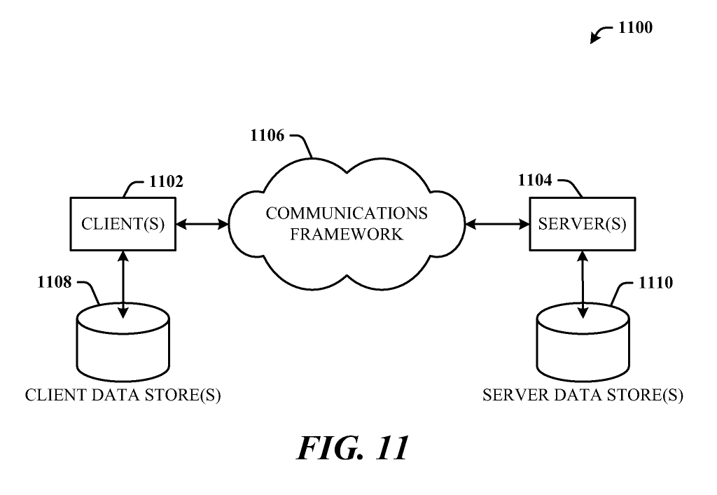

Referring now to FIG. 11, there is illustrated a schematic block diagram of a computing environment 1100 that facilitates messaging server extensibility in accordance with the disclosed architecture. The environment 1100 includes one or more client(s) 1102. The client(s) 1102 can be hardware and/or software (e.g., threads, processes, computing devices). The client(s) 1102 can house cookie(s) and/or associated contextual information, for example.

The environment 1100 also includes one or more server(s) 1104. The server(s) 1104 can also be hardware and/or software (e.g., threads, processes, computing devices). The servers 1104 can house threads to perform transformations by employing the architecture, for example. One possible communication between a client 1102 and a server 1104 can be in the form of a data packet adapted to be transmitted between two or more computer processes. The data packet may include a cookie and/or associated contextual information, for example. The environment 1100 includes a communication framework 1106 (e.g., a global communication network such as the Internet) that can be employed to facilitate communications between the client(s) 1102 and the server(s) 1104.

Communications can be facilitated via a wire (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented message communications system, comprising:
a messaging server for receiving a message; and
a routing component for routing message information of the message to a remote location for processing using custom code and receiving instructions from the remote location as to handling of the message.

2. The system of claim 1, wherein the routing component issues a web service call to the remote location, which is a web service.

3. The system of claim 1, wherein the instructions received from the remote location indicate to the messaging server to accept or reject the message.

4. The system of claim 1, wherein the instructions received from the remote location indicate to the messaging server to redirect the message.

5. The system of claim 1, wherein the routing component sends the message to the remote location, the remote location modifies the message, returns the modified message to the messaging server, and returns instructions to the messaging server as to processing of the modified message.

6. The system of claim 1, wherein the routing component sends the message to the remote location and, the remote location processes the message information using the custom code and the remote location receives and sends the message directly to a recipient based on the message information.

7. The system of claim 1, wherein the routing component processes configuration data that describes conditions for routing the message, to which remote location of a plurality of remote locations the message is to be routed, and message information to be sent from the messaging server to the remote location.

8. The system of claim 7, wherein the message information indicates the message is from a source outside of a domain of the messaging server.

9. The system of claim 1, wherein the routing component sends additional information to the remote location in response to a request by the remote location.

10. A computer-implemented message communications system, comprising:
a messaging server for sending and receiving messages;
a configuration component for defining conditions under which the messaging server calls a web service; and
a routing component for routing the message to the web service according to one or more of the conditions, the web service processing the message using custom code and returning instructions to the messaging server as to handling of the message.

11. The system of claim 10, wherein the conditions describe criteria for initiating routing of the message, a web service of a plurality of web services the message is to be routed, and message information to be sent from the messaging server to the selected web service.

12. The system of claim 10, wherein the web service returns instructions to the messaging server to accept the message, reject the message, or to redirect the message.

13. The system of claim 10, wherein the web service modifies the message, returns the modified message to the messaging server, and returns instructions to the messaging server to continue processing the modified message.

14. The system of claim 10, wherein the web service requests additional information from the messaging server as part of processing the message.

15. A computer-implemented method of processing messages, comprising:
receiving a message at a messaging server for processing;
analyzing the message according to conditions;
routing the message to a remote location for processing using custom code based on one or more of the conditions;
returning instructions to the messaging server as to processing of the message; and
processing the message at the messaging server according to the instructions.

16. The method of claim 15, further comprising accepting or rejecting the message at the messaging server based on the instructions.

17. The method of claim 15, further comprising routing the message to the remote location, which is a web service, based on the message being received from a network external to a domain of the messaging server.

18. The method of claim 15, further comprising sending additional message information to the remote location in response to a request for the additional message information by the remote location.

19. The method of claim 15, further comprising receiving a modified message from the remote location, the remote location modifying the message, and processing the modified message according to the instructions.

20. The method of claim 15, further comprising reporting latency parameters of the messaging service independent of latency data of the remote location.
